(19) United States
(12) Patent Application Publication
(10) Pub. No.: US 2021/0292057 A1
(43) Pub. Date: Sep. 23, 2021

(54) VALVE DEVICE, LID ASSEMBLY, CONTAINER AND USAGE THEREOF

(71) Applicant: HUNTSMAN ADVANCED MATERIALS LICENSING (SWITZERLAND) GMBH, Basel (CH)

(72) Inventors: Wing Lok LAW, Kowloon (HK); Ling Yan FU, Guangzhou, Guangdong (CN); Cheng ZHANG, Guangzhou, Guangdong (CN); Chi Fai CHOW, Shatin (HK); Xin LIN, Foshan, Guangdong (CN)

(21) Appl. No.: 16/500,104

(22) PCT Filed: Apr. 7, 2017
(86) PCT No.: PCT/CN2017/079653

§ 371 Date: Oct. 2, 2019

(51) Int. Cl. B65D 51/16; F16K 24/04; F16K 15/14

(52) U.S. Cl. CPC B65D 51/1644; F16K 15/148; F16K 24/04

(57) ABSTRACT

The present invention relates to a valve device characterized in that it comprises a valve component and a membrane component. The valve component comprises a bottom cover with one or more first apertures; a top cover with one or more second apertures, wherein the bottom cover and the top cover enclosing a venting chamber; a plate accommodated inside the venting chamber and being pressed by one or more projections attaching to the top cover against the one or more second apertures on the bottom cover; and wherein silicon oil is provided between the bottom cover and the plate; and wherein the plate has a diameter between 5 mm and 20 mm. The membrane component comprises a membrane made from hydrophobic material.

### TECHNICAL FIELD

The present invention is related to storing apparatus and method of storage. More particularly, the present invention is related to a valve device, a lid assembly and a container. Moreover, the present invention also relates to the usage of the valve device and lid assembly, as well as a process for preparing a liquid container system.

### BACKGROUND OF INVENTION

It is known in the prior art that jerricans or drum-like containers are applied to store variety of items. However, some stored items tend to generate gas as time goes by. For example, during the storing of some chemical industrial material, the stored items tend to generate gases such as carbon dioxide or others. If these gases were not properly exhausted to the outside of the container, these gases will lead the container to swell to an undesired extent. Several solutions have been developed to deal with this problem. For example, one or more valve bodies may be applied on the container or the lid. These valve bodies may be dual way valves and they are designed to exhaust the accumulated gas inside the container to the ambient atmosphere, so as to mitigate the swelling problems in the container. However, the dual-way valve bodies in the prior art may also introduce some gases in the ambient atmosphere into the container, such as the water vapor or carbon dioxide.

The permeation of ambient gases is generally undesired, since some stored items tend to crystallize in the ambient atmosphere. The typical crystallized areas include the inner edges of the lid, the exterior and interior of the valve body opening, etc. These crystallized bodies may block the valve or the venting passage, and thus lead to undesired valve body failure. Additionally, the crystallized materials are generally discarded and unable to use again. During lone-term storing, all stored items in the container may spoil due to such a valve leakage.

Thus, there is a continuing need to develop an improved apparatus which can enhance the safety, performance and cost-effectiveness of item storing. One purpose of this invention is to provide a valve device, a lid assembly and a container that may exhaust the inner gas while stop the undesired ambient atmosphere from entering the interior. Other purposes refer to the usage of the valve device and lid assembly, as well as a process for preparing a liquid container system.

### SUMMARY OF THE INVENTION

The present invention may be characterized as a valve device that comprises: a valve component which comprises a bottom cover with one or more first apertures; a top cover with one or more second apertures, wherein the bottom cover and the top cover enclosing a venting chamber; a plate accommodated inside the venting chamber and being pressed by one or more projections attaching to the top cover against the one or more second apertures on the bottom cover; and wherein silicon oil is provided between the bottom cover and the plate; and wherein the plate has a diameter between 5 mm and 20 mm; and a membrane component which comprises a membrane made from hydrophobic material,

Preferably, the plate is made from silicon or rubber.

Preferably, the plate has a diameter between 7 mm and 12 mm.

Preferably, the hydrophobic material is expanded polytetrafluoroethylene.

The present invention may also be characterized as a lid assembly that it comprises the valve device.

The present invention may also be characterized as a container in that it comprises: a container body for storing items; a port access to the interior of the container body; and a lid assembly, wherein the lid assembly is configured to mate and seal the port.

The present invention may also be characterized as a method for preparing a liquid container system

The present invention may also be characterized as usage of the valve device in the package of liquid.

The present invention may also be characterized as usage of the lid assembly in the package of liquid.

The valve device, lid assembly, the container in the present invention may provide better solutions for item storage by eliminating the container swelling due to interior gas generation and stopping the water vapor in the ambient atmosphere from entering the container. The solutions in the present invention may also benefit from simple configuration and ease of manufacturing.

### BRIEF DESCRIPTION OF THE DRAWINGS

The above and other aspects, features, and advantages of the present invention will be more apparent from the following, more detailed description thereof, presented in conjunction with the following drawings, in which:

FIG. 1 is a schematic perspective view of an embodiment of lid assembly;

FIG. 2 is an exploded view of the embodiment as shown in FIG. 1;

FIG. 3 is a schematic cross-sectional illustration of the valve component as shown in FIG. 2;

FIG. 4 is a schematic cross-sectional perspective view of the membrane component as shown in FIG. 2; and

FIG. 5 is a schematic illustration of installing the lid assembly shown in FIG. 1 onto a container.

For the sake of avoiding repetition, some of the common elements in the various Figs utilize the same numbers where the explanation of such elements would not change from Fig. to Fig.

### DETAILED DESCRIPTION

Detailed descriptions of specific embodiments of the lid assembly, container and method of storage are disclosed herein. It will be understood that the disclosed embodiments are merely examples of the way in which certain aspects of the invention can be implemented and do not represent an exhaustive list of all of the ways the invention may be embodied, Indeed, it will be understood that the lid assembly, container and method of storage described herein may be embodied in various and alternative forms. The figures are nor necessarily to scale and some features may be exaggerated or minimized to show details of particular components. Well-known components, materials or methods are not necessarily described in great detail in order to avoid obscuring the present disclosure. Any specific structural and functional details disclosed herein are not to be interpreted as limiting, but merely as a basis for the Claims and as a representative basis for teaching one skilled in the art to employ the invention in a variety of ways.

FIG. 1 is a schematic perspective view of an embodiment of lid assembly 10. Specifically, FIG. 1 shows a lid assembly 10 with a lid body 100 and a valve component 200 provided on the lid body 100. In the illustrated embodiment, the lid assembly 10 is configured in axial symmetry and the valve component 200 is assembled in the axis of the lid body 100. Alternatively, the lid assembly 10 may be configured in other geometries and the valve component 200 may be arranged eccentrically.

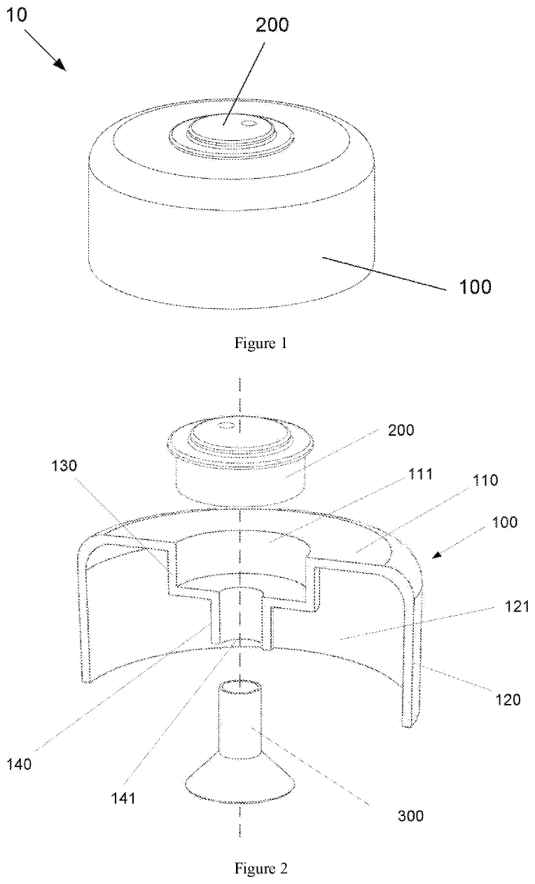

FIG. 2 is an exploded view of the lid assembly 10 shown in FIG. 1. It will be appreciated by one skilled in the art that the lid body 100 is illustrated in cross-sectional view for the sake of clarity. The lid body 100 includes: a top portion 110 with a first opening 111; a peripheral wall 120 extending in one side from the edge of the top portion 110, wherein the top portion and the peripheral encloses an internal chamber 121; a passage portion extending from the first opening 111 in the direction towards the internal chamber 121 to a second opening 141; and a valve device being fit into the interior of the passage portion.

Specifically, the valve device comprises: a valve component 200 attached to the inner surface of the passage portion and configured to provide one-way ventilation from the second opening 141 to the first opening 111; and a membrane component 300 attached to the inner surface of the passage portion and configured to prevent liquid stored items from getting through. The details of the valve component 200 and the membrane component 300 will be mentioned in the following disclosure.

The passage portion comprises: a first housing portion 130 extending from the first opening 111 in the direction towards the internal chamber 121; and a second housing portion 140 extending from the bottom of the first housing portion 130 and providing the second opening 141 towards the internal chamber 121.

In the illustrated embodiment, the first housing portion 130 forms a step-shaped configuration and is configured to accommodate the valve component 200, while the second housing portion 140 is configured in bushing shape to accommodate the membrane component 300. The valve component 200 may fit into the first housing portion 130 through the first opening 111, while the membrane component 300 may fit into the second housing portion 140 through the second opening 141.

In another embodiment of this invention, the valve component 200 and the membrane component 300 may both fit into the passage portion through the first opening 111 or the second opening 141.

In another embodiment of this invention, a multiple of valve components and/or a multiple of membrane components may be provided to fit into the passage portion.

In another embodiment of this invention, the inner surface of the peripheral wall 120 may provide with a screw.

In another embodiment of this invention, the outer surface of the peripheral wall 120 may provide with a multiple of projections to assist the rotation of the lid assembly 10.

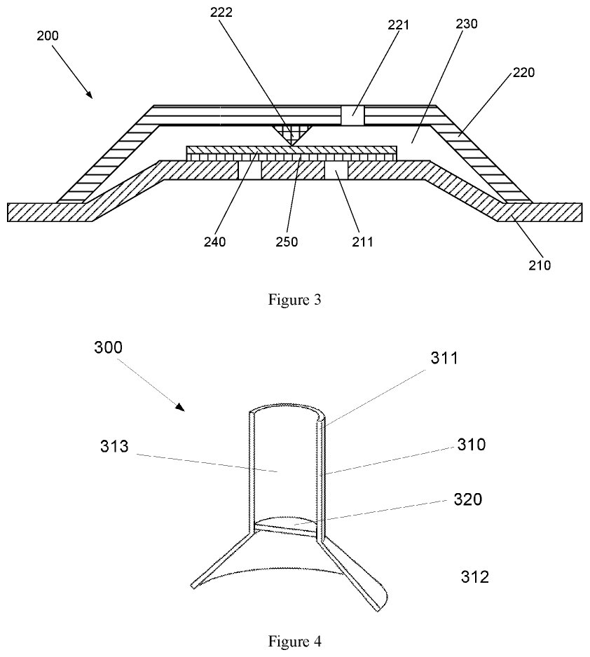

FIG. 3 is a schematic cross-sectional illustration of the valve component 200 shown in FIG. 2. The valve component 200 may be one-way valve, such as the one-way valve for coffee bag or other types of suitable one-way valves. The valve component 200 as illustrated in FIG. 3 comprises: a bottom cover 210 with one or more first aperture 211 extending therethrough; a top cover 220 with at least one second aperture 221 extending therethrough; the top cover 220 being provided to attached to the bottom cover so as to enclose a venting chamber 230 between the bottom cover 210 and the top cover 220; a plate 240 being provided inside the venting chamber 230 and pressed by a pressing portion 222 projecting from the top cover 220 toward the bottom cover 210 so as to cover one or more first apertures 211; wherein a silicon oil 250 may be provided between the plate 240 and the bottom cover 210. The silicon oil can effectively prevent air getting back into the container during gas release.

When the valve component is fit in place, the surrounding of the bottom cover 210 or top cover 220 may attach to the inner surface of the first housing portion 130, while the at least one first aperture 211 is facing the membrane component 300 and the at least one second aperture 221 is facing the first opening 111.

Preferably, the plate 240 is made from silicon or rubber.

Preferably, the diameter of the plate 240 is from 5 mm to 20 mm, preferably from 7 mm to 12 mm. The diameter of the plate is longer than that in normal single way valve, which allows more gas release. In one embodiment of this invention, the plate 240 has a diameter of 9 mm and a thickness of 0.95 mm.

Preferably, the bottom cover 210 and the top cover 220 are made from plastic.

In operation, when the pressures of gases generated from the stored items accumulate in the container, a higher pressure will be applied to the bottom cover 210 of the valve component. When the pressure level in the container rises to a predetermined level, the portion between the first apertures 211 will deform and the inner gases will vent through the silicon oil 250 into the venting chamber 230, then the gases will exhaust into the ambient atmosphere through the second aperture 221. During this process, the pressure level in the container will drop down and the plate 240 will press against the first apertures to seal them against. Thus, the valve component will provide one-way ventilation for the container without allowing reversed ventilation. That is, it is possible for the vaporized stored items and gases to exhaust into the ambient atmosphere through the valve. At the same time, the water vapor in the ambient atmosphere is prevented from squeezing through the valve.

FIG. 4 is a schematic cross-sectional perspective view of the membrane component shown in FIG. 2. The membrane component 300 comprises a sleeve 310 and a membrane 320. The external surface of one end 311 of the sleeve 310 is sized to attach to the inner surface of the second housing portion 140. A membrane passage 313 is provided inside the sleeve 310.

Preferably, the membrane 320 is provided inside the membrane passage 313 to cover the entire cross section of the membrane passage 313.

Preferably, the other end 312 of the sleeve 310 is expanding in size to form a coned portion, so as to provide a better collection of inner gas. However, the other end 312 of the sleeve 310 may also be provided with other shapes.

Preferably, the membrane 320 is made from hydrophobic material such as expanded polytetrafluoroethylene. The hydrophobic membrane has roll-off properties. Liquid can easily drain off the membrane, allowing continuous airflow. If desired, other suitable materials may also be provided to manufacture the membrane 320.

Preferably, the membrane is a Gore membrane.

In another embodiment of the membrane component, the bottom of the sleeve is sealed by a removable cover, and several openings are provided on the peripheral of the sleeve between the membrane and the bottom of the sleeve.

In operation, the membrane 320 may prevent the liquid stored items from squeezing through. At the same time, the membrane 320 may allow the vaporized store items to get through.

As disclosed in FIGS. 2 and 4, the membrane 320 is arranged to face the bottom cover 210 of the valve component, and the circumference of passage between the membrane 320 and the bottom cover 210 is sealed by the sleeve 310 and the passage portion, such that the gas may not reach the first aperture 211 before penetrating through the membrane 320.

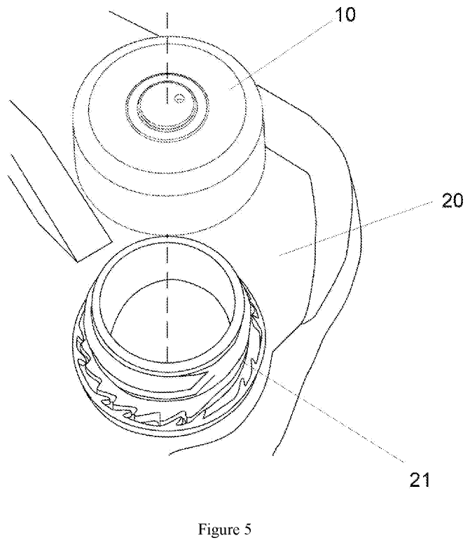

FIG. 5 is a schematic illustration of installing the lid assembly shown in FIG. 1. A container comprises: a container body 20; a port 21 arranged on a container body 20 to provide access into the interior of the container body 20; and a lid assembly 10 according to this invention provided to mate and seal port 21. The sealing may be provided by gluing, screwing or interference fit.

The container according to this invention may be jerrican, drum, barrel or other suitable containers.

This invention also relates to a process for the preparation of a liquid container system, wherein a lid assembly as disclosed above is used.

This invention also relates to the usage of the valve device as disclosed above in the package of liquid, as well as the usage of the lid assembly as disclosed above in the package of liquid.

In operation, the container as described above may be used in the following steps:

A) Removing the lid assembly from the container, so as to expose the port leading to the interior of the container body;
B) Supplying the items to be stored through the port into the interior of the container body, wherein the items may be liquid or solid product;
C) Fitting the lid assembly into the port to seal the container body; and
D) Transporting and storing the container to the desired location.

In one comparing test of known lid assembly, a lid assembly with a dual-way valve and a venting membrane is provided to seal a container. The container then is placed inside an oven to endure a temperature of 45 Celsius Degree and a relative humidity of 70%-90%. After a time period of 28 days, it has been found that although there is no crystallization in the lid assembly and the stored materials are in good condition, an unacceptable swelling has been developed in the container.

In another comparing test of known lid assembly, a lid assembly with a coffee bag valve alone is provided to seal a container. The container is shaken for 20 minutes and then is placed inside an oven to endure a temperature of 45 Celsius Degree and a relative humidity of 70%-90%. After a time period of 30 days, it has been found that the container has suffered from unacceptable swelling. The swelling is generally produced since the liquid gets into the lid assembly during the test and thus blocks the inner side of the lid assembly.

In yet another comparing test of known lid assembly, a lid assembly with a venting membrane alone is provided to seal a container, The container then is placed inside an oven to endure a temperature of 60 Celsius Degree and a relative humidity of nearly 100%. After a time period of 3 days, it has been found that the crystallization of stored items appears in the opening of the lid assembly. At the same time, the container has been swollen. Thus, it is concluded that the crystallized stored items will eventually block the entire membrane and thus stop the lid assembly from venting.

In the testing for the method of storage according to this invention, some gas generating materials are placed into a container and a lid assembly according to the disclosure above is provided to seal the container. Then the container is shaken for 20 minutes and then is placed inside an oven to endure a temperature of 45 Celsius Degree and a relative humidity of 70%-90% for 30 days, so as to estimate a storing period of one to two months under 20-30 Celsius Degree. After a time period of 30 days, it has been found that there is no swelling in the container and no crystallized material inside or outside the lid assembly.

As a result, it has been found that the lid assembly and the container according to this invention may effectively exhaust the gas generated by the stored items in the container and prevent the water vapor in the ambient atmosphere from entering the container, so as to prevent the container from swelling and keep the passage portion unblocked.

While the present invention has been described with reference to preferred embodiments, as will be understood by those skilled in the art, numerous additions and omissions can be made without departing from the spirit and scope of the present invention as set forth in the appended claims.

1. A valve device comprising:
a valve component which comprises:
a bottom cover with one or more first apertures;
a top cover with one or more second apertures, wherein the bottom cover and the top cover enclose a venting chamber; and
a plate accommodated inside the venting chamber and being pressed by one or more projections attaching to the top cover against the one or more first apertures on the bottom cover, wherein the plate has a diameter between 5 mm and 20 mm and wherein silicon oil is provided between the bottom cover and the plate; and
wherein the plate has a diameter between 5 mm and 20 mm; and
a membrane component which comprises a membrane made from a hydrophobic material.

2. The valve device according to claim 1, wherein the plate is made from silicon or rubber.

3. The valve device according to claim 1, wherein the plate has a diameter between 7 mm and 12 mm.

4. The valve device according to claim 1, wherein the hydrophobic material is expanded polytetrafluoroethylene.

5. A lid assembly comprises a valve device according to claim 1.

6. A container comprises:
a container body for storing items;
a port access to the interior of the container body; and
the lid assembly according to claim 5, wherein the lid assembly is configured to mate and seal the port.

7. A method for preparing a liquid container system, wherein a lid assembly according to claim 5 is used.

8. A liquid package comprising Usage of the valve device according to claim 1.

9. A liquid package comprising the lid assembly according to claim 5.
